(19) United States
(12) Patent Application Publication
(10) Pub. No.: US 2012/0312221 A1
(43) Pub. Date: Dec. 13, 2012

(54) Submersible vehicles and methods for propelling and/or powering the same in an underwater environment

(75) Inventor: Frederick Vosburgh, Durham, NC (US)

(73) Assignee: iRobot Corpoartion

(21) Appl. No.: 12/315,760

(22) Filed: Dec. 5, 2008

Related U.S. Application Data
(60) Provisional application No. 61/012,132, filed on Dec. 7, 2007.

(51) Int. Cl. B63H 1/32; B60L 11/00; B63H 25/00; B63G 8/14; B63G 8/08

(52) U.S. Cl. 114/331; 440/6; 440/13

(57) ABSTRACT

A submersible vehicle for use in water includes a vehicle body and a hybrid vehicle propulsion system to propel the vehicle body through the water. The hybrid vehicle propulsion system includes a passive thrust system and an active thrust system. The passive thrust system includes a force redirector and a buoyancy control system. The buoyancy control system is operable to selectively generate vertical thrust by varying a buoyancy of the submersible vehicle and the force redirector is configured to generate a glide thrust responsive to changes in the elevation of the submersible vehicle in the water. The active thrust system includes a thruster mechanism operable to selectively propel and/or steer the vehicle body through the water.

### RELATED APPLICATION(S)

This application claims the benefit of and priority from U.S. Provisional Patent Application Ser. No. 61/012,132, filed Dec. 7, 2007, the disclosure of which is incorporated herein by reference in its entirety.

### STATEMENT OF GOVERNMENT SUPPORT

This invention was made with support under Small Business Innovation Research (SBIR) Program No. N00014-07-C-0360 awarded by the United States Navy Office of Naval Research (ONR). The Government has certain rights in the invention.

### FIELD OF THE INVENTION

The present invention relates to water submersible devices and methods for propelling and/or powering the same.

### BACKGROUND OF THE INVENTION

Monitoring of the oceans and other bodies of water for purposes of scientific research, national defense, or commercial development is becoming increasingly automated to reduce costs. For example, unmanned undersea vehicles (UUV) have emerged as key tools in the offshore engineering industry. And considerable investment is being made by nations around the world to develop UUVs for national or homeland defense. With the increasing requirement for persistent intelligence, surveillance and reconnaissance (ISR) operations in areas where access is denied or where ISR is otherwise desirably clandestine, UUVs will be increasingly put to use. Use of UUVs to service devices historically tended by submarines, deep submersible vehicles and divers will substantially reduce cost and risk to the operators. So, it can be seen, persistent ISR and other activities in problematic areas drive the need for means of sensing and communicating that do not require human intervention or costly engineering systems.

### SUMMARY OF THE INVENTION

According to embodiments of the present invention, a submersible vehicle for use in water includes a vehicle body and a hybrid vehicle propulsion system to propel the vehicle body through the water. The hybrid vehicle propulsion system includes a passive thrust system and an active thrust system. The passive thrust system includes a force redirector and a buoyancy control system. The buoyancy control system is operable to selectively generate vertical thrust by varying a buoyancy of the submersible vehicle and the force redirector is configured to generate a glide thrust responsive to changes in the elevation of the submersible vehicle in the water. The active thrust system includes a thruster mechanism operable to selectively propel and/or steer the vehicle body through the water.

According to method embodiments of the present invention, a method of propelling a submersible vehicle through water includes providing a submersible vehicle for use in water, the submersible vehicle including a vehicle body and a hybrid vehicle propulsion system to propel the vehicle body through the water. The hybrid vehicle propulsion system includes a passive thrust system including a force redirector and a buoyancy control system, and an active thrust system including a thruster mechanism. The method further includes: selectively generating vertical thrust by varying a buoyancy of the submersible vehicle using the buoyancy control system and thereby changing the elevation of the submersible vehicle in the water, responsive to which the force redirector generates a glide thrust; and propelling and/or steering the vehicle body through the water using the thruster mechanism.

According to embodiments of the present invention, a submersible vehicle for use in water includes a water submersible vehicle body and a recharging system associated with the vehicle body. The recharging system includes a convertor operative to convert environmental potential proximate the vehicle to electrical energy.

According to embodiments of the present invention, a submersible vehicle for use in water includes a vehicle body and a fin propulsion system. The fin propulsion system includes a pair of opposed fins, a pair of pitch actuators each associated with a respective one of the fins to selectively vary a pitch of the associated fin, and a heave actuator to selectively change a heave angle between the fins.

According to method embodiments of the present invention, a method for propelling a submersible vehicle through water, the vehicle having first and second opposed fins, includes: selectively varying the respective pitches of first and second fins using first and second pitch actuators associated with the first and second fins, respectively; and selectively change a heave angle between the first and second fins using a heave actuator.

Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE DRAWINGS

FIG. 1 is a perspective view of a water submersible vehicle according to embodiments of the present invention.

FIG. 2 is a schematic side view of the vehicle of FIG. 1.

FIG. 3 is a schematic front view of a fin propulsion system of the vehicle of FIG. 1.

FIG. 4 is a schematic view of the vehicle of FIG. 1 illustrating operation of a passive thrust system of the vehicle.

FIG. 5 is a schematic side view of the fin propulsion system of FIG. 3 illustrating operation thereof.

FIG. 6 is a top view of a payload module of the vehicle of FIG. 1.

FIG. 7 is a schematic side view of the vehicle of FIG. 1 illustrating operation of a recharging system of the vehicle.

FIG. 8 is a perspective view of a water submersible vehicle including a propeller propulsion system according to further embodiments of the present invention.

### DETAILED DESCRIPTION OF EMBODIMENTS OF THE INVENTION

The present invention now will be described more fully hereinafter with reference to the accompanying drawings, in which illustrative embodiments of the invention are shown. In the drawings, the relative sizes of regions or features may be exaggerated for clarity. This invention may, however, be embodied in many different forms and should not be construed as limited to the embodiments set forth herein; rather, these embodiments are provided so that this disclosure will be thorough and complete, and will fully convey the scope of the invention to those skilled in the art.

It will be understood that when an element is referred to as being “coupled” or “connected” to another element, it can be directly coupled or connected to the other element or intervening elements may also be present. In contrast, when an element is referred to as being “directly coupled” or “directly connected” to another element, there are no intervening elements present. Like numbers refer to like elements throughout. As used herein the term “and/or” includes any and all combinations of one or more of the associated listed items.

In addition, spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the electronics device in use or operation in addition to the orientation depicted in the figures. For example, if the electronics device in the figures is turned over, elements described as “under” or “beneath” other elements or features would then be oriented “over” the other elements or features. Thus, the exemplary term “under” can encompass both an orientation of over and under. The electronics device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein. Well-known functions or constructions may not be described in detail for brevity and/or clarity.

As used herein, “submersible” means an object that is water submersible and constructed such that electronic and other water sensitive components thereof are protected from contact with the surrounding water.

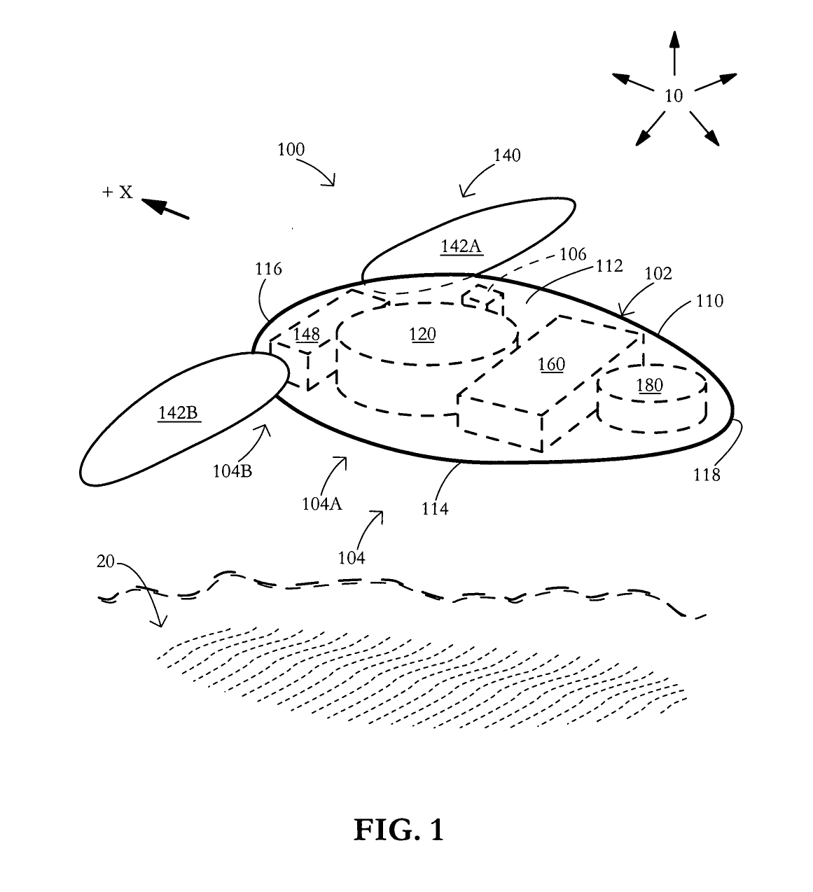

With reference to FIGS. 1-7, a water submersible vehicle 100 according to embodiments of the present invention is shown therein in a body of water 10 (e.g., a sea or ocean). According to some embodiments, the vehicle 100 is an unmanned underwater vehicle (UUV) or autonomous underwater vehicle (AUV). The vehicle 100 can be used for sensing, payload deploying, object servicing, and communicating in aquatic environments, for example. The vehicle 100 includes a vehicle body 102, a hybrid propulsion system 104, a vehicle controller 106, a payload 160, and a recharging system 181. However, it will be appreciated that other embodiments of the invention may not include certain of these components, systems or subcomponents.

The hybrid propulsion system 104 is operable to propel the vehicle body 102 through the water 10 and with respect to an associated substratum 20. The hybrid propulsion system 104 includes a passive thrust system 104A and an active thrust system 104B, each of which is described in more detail below.

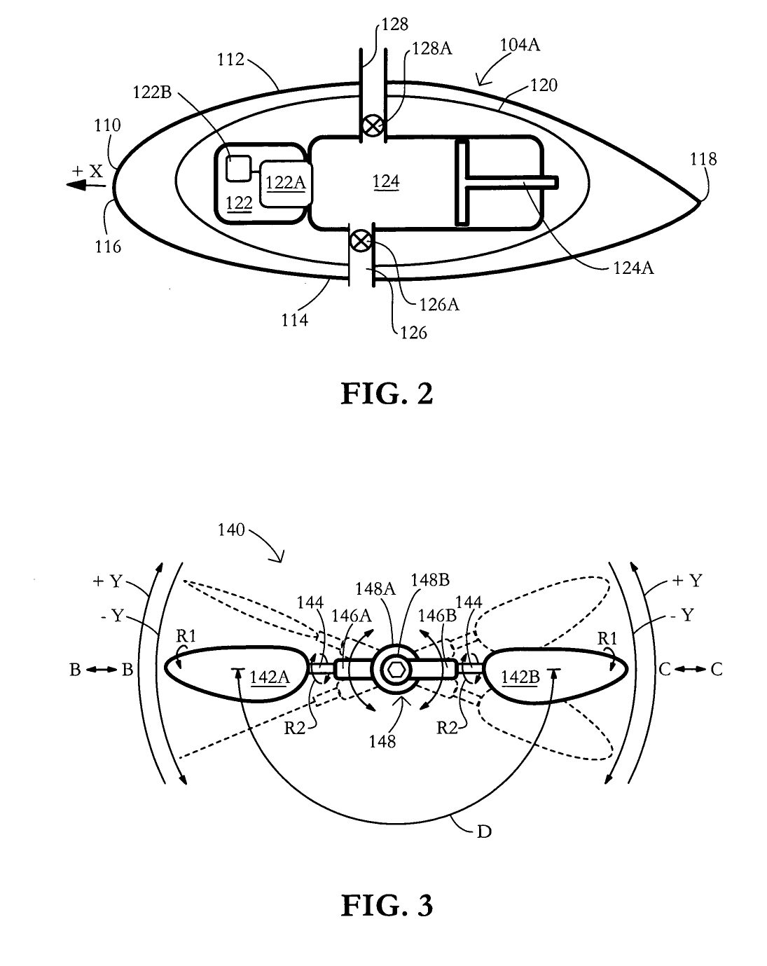

The passive thrust system 104A (FIG. 2) includes a hull 110 and a buoyancy control system 120 that cooperate to generate forward thrust (e.g., in a forward direction +X as indicated in FIGS. 1, 2, 4 and 5). In general, the buoyancy control system 120 is operable to selectively change the buoyancy of the vehicle body 102 and thereby generate a vertical force that the shape of the hull 110 converts at least partly into displacement in the forward direction. The hull 110 operates as a force redirector and is configured such that it generates a forward glide thrust responsive to changes in the elevation of the hull 110. In some cases, fins 142 as described hereinbelow can serve as force redirectors and, more particularly, can be oriented as further means of converting changes in hull elevation into forward glide thrust, similar to operation of the wing of a plane. According to some embodiments, the hull 110 is configured to generate a forward glide thrust both as the hull 110 rises and as the hull 110 drops due to variations in the buoyancy of the body 102. Aspects of the hull 110 and the buoyancy control system 120 will now be described. However, other hull configurations and buoyancy control mechanisms than those described and shown may be employed in some embodiments of the present invention.

With reference to FIGS. 1 and 2, the hull 110 has an upper surface 112, a lower surface 114, a front end 116 and an opposing rear end 118. The front end 116 is the end that leads when the hull 110 is driven through the water 10 by the hybrid propulsion system 104 in the forward direction +X and the rear end 118 is the end that trails when the hull 110 is driven through the water 10 by the hybrid propulsion system 104 in the forward direction +X. The hull 110 is sized and shaped to provide a desired lift and/or drag (which may be expressed as a lift/drag ratio (LDR)). In some embodiments, the hull 110 is sized and shaped to contain desired components and payload. The hull 110 is configured such that, when the hull 110 is subjected to a vertical thrust in the water 10, the hull 110 will convert at least a portion of said vertical thrust into forward thrust (i.e., in the direction +X). That is, when a vertical flow of the water 10 is applied across the hull 110, the hull 110 will generate a reaction force that is transverse to vertical (i.e., has a horizontal force vector).

In some embodiments, the hull 110 has a lift producing shape, with “lift” defined as a force at least partly orthogonal to the surface of the hull 110, which force is generated by faster movement of a fluid or gas over that surface, according to what is commonly known as Bernoulli's principle. In some cases, the vehicle 100 includes one or more control surfaces such as a rudder. In some cases, the vehicle 100 can further include a housing in which components can be mounted (e.g., a sensor, a processor, an energy storage device, communications electronics, and/or a payload or payload managing devices).

With reference to FIG. 2, in some embodiments, the buoyancy control system 120 includes a gas generator 122, a reservoir 124, an outlet 126, and an outlet 128. The gas generator 122 is operable to generate a displacement gas to displace water from the reservoir 124 to thereby lower the density of the vehicle 100 and increase its buoyancy. In some embodiments, the gas generator 122 includes a mixer 122A and a supply 122B or supplies of one or more gas generation substances can generate a gas when mixed with one another or with water. The mixer 122A is operable to mix the gas generation substances to generate the gas to displace water from the reservoir 124. According to some embodiments, the supply 122B includes lithium hydride, carbide, calcareous material, or a peroxide combinable with an aqueous solution (which may be contained in the vehicle or sourced from the environment) to generate the displacement gas. According to some embodiments, the supply 122B includes lithium hydride and an aqueous solution that are combined by the mixer 122A to implement a chemical reaction and provide hydrogen gas to the reservoir 124. The gas generator 122 may additionally or instead include a converter unit that can convert a liquid or gas at least partly into a gas, such as by catalysis or by providing energy. The gas generator 122 may additionally or instead include a container containing a compressed gas that can selectively release the gas.

The outlet 126 may be permanently open or selectively closable (e.g., by a valve 126A). The outlet 126 is situated in the lower surface 114 and provides an escape passage for displacement gas volume in excess of the capacity of the reservoir 124 (e.g., due to an increase in volume caused by a change in ambient pressure). When in a closed position, the valve 126A can retain gas within the reservoir 124 and thereby provide a vehicle 100 having a fixed density.

A purge valve 128A is provided in the outlet 128. The purge valve 128A can be used to selectively release the displacement gas from the reservoir 124 so that the gas is replaced with water (e.g., entering through the outlet 126).

A volume adjustment mechanism may be provided in association with the reservoir 124 to change the effective capacity of the reservoir 124 and, thereby, vehicle buoyancy. An illustrative volume adjustment mechanism is a piston 124A as shown in FIG. 2 within a cylindrical reservoir 124. The piston 124A can be moved within the reservoir 124 to change the reservoir capacity. In some cases, the vehicle 100 can comprise a volume adjustment mechanism 124A without a gas generator 120.

The gas generator 122, the piston 124A and/or the valves 126A, 128A may be selectively controlled by the vehicle controller 106 as discussed below to effect desired propulsion of the vehicle 100.

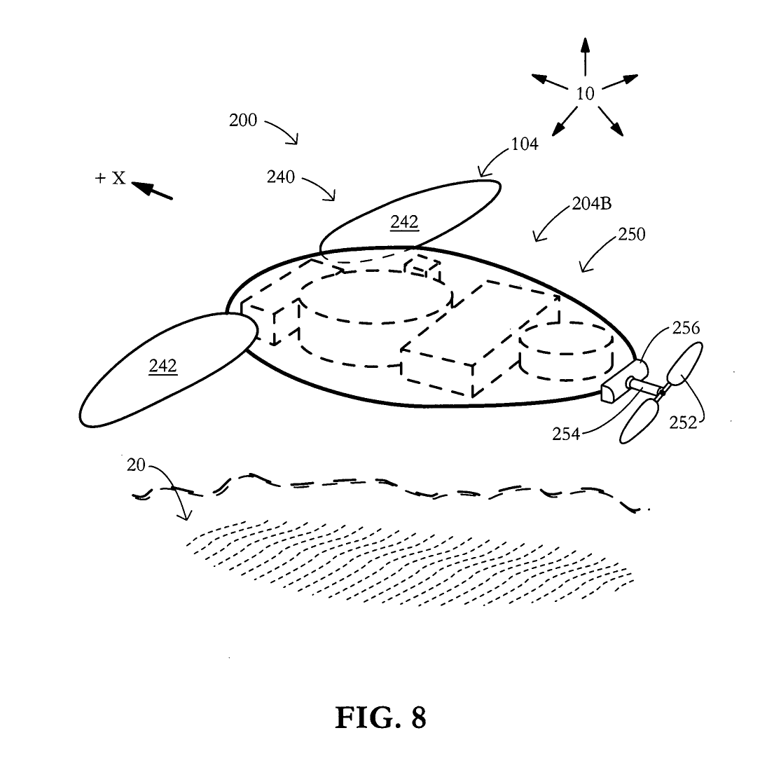

The active thrust system 104B of the hybrid propulsion system 104 includes a thruster mechanism that may be of any suitable type that can provide active thrust and/or steering, which may include any combination of translational, rotational, and distortional thrust. According to some embodiments, the active thrust system 104B includes a fin propulsion system, which comprises one or more fins. However, further embodiments of the invention may include, in addition to or in place of a fin system, other types of active thrust mechanisms such as a propeller mechanism (e.g., as discussed below with reference to FIG. 8). In some cases, the fin system includes one or more actuators (e.g., motors) and one or more fin members associated with the actuator(s) and having desirable physical properties, such as size, shape, stiffness, strength, flexibility, articulation, and/or actuation to transfer force from the actuator(s) to the water 10 or from the water to the body 102. The actuator or actuators may be any suitable actuators that can provide fin movement and/or change in shape, size, and/or stiffness to provide active thrust.

With reference to FIGS. 1, 3 and 5, a fin propulsion system 140 according to some embodiments of the present invention is shown therein. In this example, the fin propulsion system 140 includes two contralateral fins 142A and 142B. In some embodiments, the fins 142A, 142B have a lift providing or generating shape. In some embodiments, the fins 142A, 142B are cambered in section. In some embodiments, the fins 142A, 142B are flexible or compliant. In some cases, the fins 142A, 142B are low drag.

Each fin 142A, 142B is mounted on a respective shaft 144 that is in turn operatively coupled to a respective rotational or pitch actuator 146A, 146B such as an oscillation capable actuator (herein oscillator). The pitch actuator 146A is operable to rotate the fin 142A about a pitch axis B-B (FIG. 3). The pitch actuator 146B is operable to rotate the fin 142B about a pitch axis C-C (FIG. 3).

The pitch actuators 146A, 146B may be actuators of any suitable type and, according to some embodiments, are electric motors. Each shaft 144 may be of any suitable construction capable of transmitting torque to its respective fin 142A, 142B from the pitch actuator 146A, 146B to rotate the fin 142A, 142B about its pitch axis B-B, C-C. More particularly, each pitch actuator 146A, 146B is operable to at least partially forcibly rotate its associated shaft 144, and thereby each fin 142A, 142B, in a forward rotational direction R1 and a reverse rotational direction R2. The pitch actuators 146A, 146B thus provide pitch motion to each fin 142A, 142B. According to some embodiments, each pitch actuator 146A, 146B is operable to at least partially forcibly rotate its associated shaft 144 independently of the other shaft 144. That is, the pitch angles of the fins 142A, 142B can be independently set and varied.

Each pitch actuator 146A, 146B is in turn mounted on a heave actuator 148. The heave actuator 148 may be any suitable device that can selectively change a heave angle D (FIG. 3) between the fins 142A, 142B. According to some embodiments, the heave actuator 148 includes a rotator that can control the heave angle. According to some embodiments and as illustrated, the heave actuator 148 is an electric motor including a rotating rotor 148A that can rotate with respect to a cooperating stator 148A about a heave axis E-E (FIG. 5). The fin 142B is coupled to the rotor 148B (via the shaft 144 and the pitch actuator 146B) for movement therewith, and the fin 142A is coupled to the stator 148A (via the shaft 144 and the pitch actuator 146A) for movement therewith. According to some embodiments, the stator 148A is coupled to the body 102 via a coupling (e.g., a bearing) that permits relative rotation between the heave actuator 148 and the body 102. In this way, the concurrent rotation of the rotor 148B and the stator 148A, and thereby heave movement of the fins 142A, 142B, is permitted.

The heave actuator 148 is operable to forcibly change the heave angle D between the shafts 144 and, in some cases, the angles of the shafts 144 with respect to the hull 110. More particularly, the heave actuator 148 can raise each shaft 144 in an upward direction +Y and in a downward direction −Y, the magnitude of which movement can differ from that of the other shaft 144. The heave actuator 148 thus provides heave motion to each fin 142A, 142B, the magnitude being at least partly reflective of heave actuator action and of fin orientation (in particular, pitch angle G (FIG. 5)) with respect to the movement in the +Y direction. In some cases, movement of the fins 142A, 142B in the Y direction can differ, such as to provide roll in a banking turn.

The heave actuator 148 and the pitch actuators 146A, 146B may be selectively controlled by the vehicle controller 106 as discussed below to provide desired magnitude, rotation, and/or direction of propulsion of the vehicle 100. The controller 106 can coordinate the actions of the heave actuator 148 and the pitch actuators 146A, 146B. In some cases, the vehicle controller 106 selectively provides electrical power to the pitch actuators 146A, 146B and/or the heave actuator 148. As discussed in more detail below, the vehicle controller 106 can coordinate actuation of the heave actuator 148 and the pitch actuators 146A, 146B to force the fins 142A, 142B to travel in a heave-yoke path or pattern to propel the vehicle 100 through the water 10.

With reference to FIG. 7, the recharging system 181 includes a recharger 180 operable to convert environmental potentials into electrical energy usable by the vehicle 100. According to some embodiments, the recharger 180 comprises a bioreactor or fuel cell such as disclosed in U.S. Pat. No. 6,913,854 to Alberte et al., the disclosure of which is incorporated herein by reference. In some embodiments, the recharger 180 can convert redox potentials at the surface of an aquatic sediment 20, for example those established by bacterial activity in a region 184A below the vehicle 100. The recharger 180 includes one or more anode type electrodes 182 mounted in a bay 184 of the recharger 180. In some cases, the vehicle 100 comprises a barrier portion 186 that can substantially impede flow of water with respect to the bay 184 except through the sediment 20. A cathode 183 of any suitable type that can function as an electrode is mounted outside the bay 184 and the hull 110. According to some embodiments, the cathode 183 can be mounted on the hull 110 as shown; however, the cathode may be located elsewhere. The recharger system 181 may include a battery 188 or other suitable type of energy storing component that can receive and store electrical charge from the recharger 180 and provide usable energy to the vehicle 100.

In some embodiments, the recharging system 181 also includes a flow control system 186 to direct water into, through and out of the bay 184. The flow control system 186 can include an extendable and retractable skirt or barrier 186A, an outlet 186B, a pump 186C and a valve 186D. The outlet 184B permits flow of water from the sediment region 184A upward through the recharger 180 and into the surrounding water 10.

The recharger 180 may also include a conduit 189 to conduct energy and/or data between (to and/or from) the vehicle 100 and a secondary object 1000 such as a sensor or communication device. In some cases, the conduit 189 includes a coupling device 189A that can conduct energy and/or data. The coupling device 189A may be, for example, a physical contact connector and/or a noncontact connecting device that enables a wireless, radio, optical, electromagnetic, electrical, and/or inductive connection, for example.

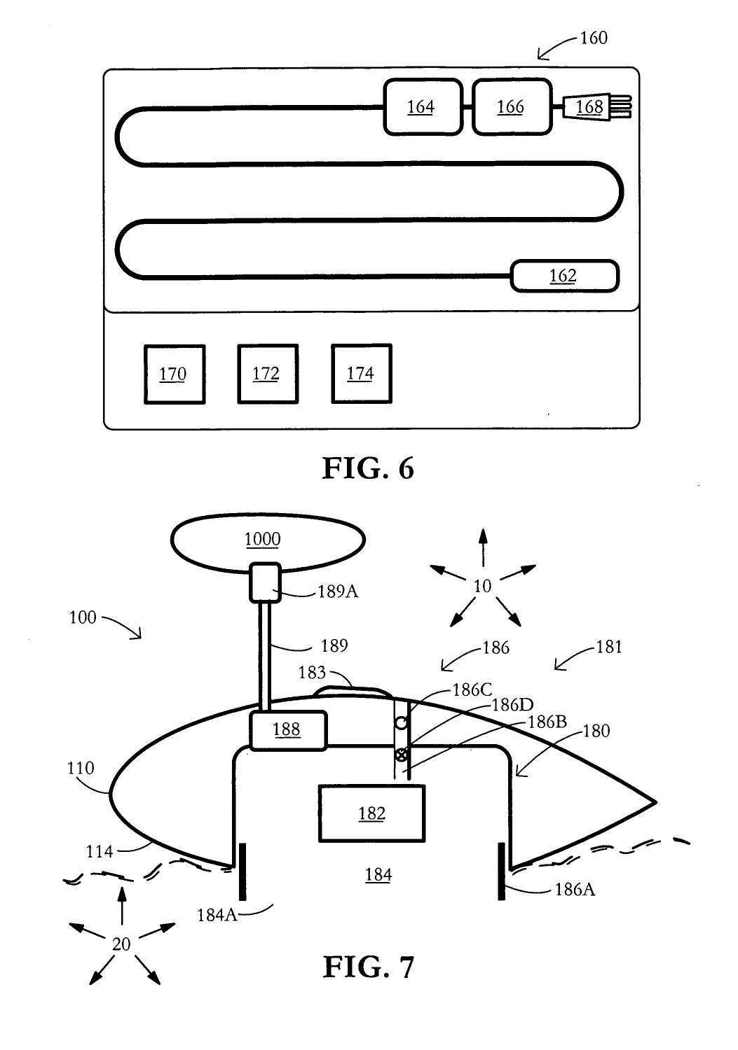

The payload 160 may be provided as a module and may include components for vehicle guiding/navigating, sensing, communicating, operating, causing, neutralizing, marking, material-providing, and/or mass-altering, for example. Referring to FIG. 6, in some cases the payload module 160 includes a deployable device 162, such as an acoustic communication node or a sonar or other sensor array. In some cases, the deployable device 162 includes a receiver that can receive energy and/or data conducted from the vehicle 100. In some cases, the payload includes a payload battery 164 and a payload memory 166 for storing products of receiving, and a receiver connector 168, which can be of any type that can receive a submersible connector.

The payload 160 may include a communication system or module 170, which may include a radio, acoustic modem and/or light emitting device, for example. In some cases, the communication system or module 170 includes a deployable portion such as a releasable buoyant radio or antenna.

The payload 160 may include a sensing device or module 172 operative to sense one or more desired parameters, conditions and/or events. For example, the sensing system or module 172 may detect an environmental parameter such as an attribute of the water (e.g., conductivity, temperature, depth, water current, turbulence, luminescence, turbidity, presence or concentration of dissolved oxygen, pH, or chlorophyll presence or concentration), or acoustic noise.

The payload 160 may include a guidance module or system 174. The guidance system 174 may include a guidance system as disclosed in Applicant's U.S. Published Patent Application No. US-2008-0239874-A1, published on Oct. 2, 2008, titled “Underwater Guidance Systems, Unmanned Underwater Vehicles and Methods,” the disclosure of which is incorporated herein by reference.

The vehicle controller 106 controls the operation and interoperation of the various modules and systems. The vehicle controller 106 may include any suitable electronics (e.g., a microprocessor), software and/or firmware configured to provide the functionality described herein. While the controller 106 is illustrated herein schematically as a single module, the vehicle controller 106 may be functionally and physically distributed over multiple devices or subsystems.

Methods and operations of the vehicle 100 according to some embodiments of the invention will now be described in further detail.

The vehicle 100 may be deployed in the water 10 in any suitable manner. The vehicle 100 may first be prepared for an operation by providing the vehicle 100 with navigational and/or operational instructions, for example. In some cases, the vehicle 100 is initially released at a location other than a target operations area where operational activity of the vehicle is desired (i.e., remote from a region where the presence of the vehicle 100 is ultimately intended) and the vehicle 100 navigates to the operations area. The vehicle 100 may transit to and/or from the operations area. In some cases, the vehicle 100 survey transits at least a portion of the operations area. In some cases, the vehicle 100 transits to a pickup or scuttling location.

Navigation or transit of the vehicle 100 can be provided by the hybrid propulsion system 104 which controllably propels the vehicle body 102. More particularly, depending on the operational need or intended transit, the body 102 can be propelled by the passive thrust system 104A alone, the active thrust system 104B alone, or the passive thrust system 104A and the active thrust system 104B together.

The passive thrust system 104A propels the vehicle 100 in the forward direction +X by changing the buoyancy of the vehicle 100. The buoyancy control system 120 alters the buoyancy of the vehicle 100 by selectively generating gas (via the gas generator 122) to purge water from the reservoir 124, releasing or purging gas from the reservoir 124 (e.g., via the purge valve 128A and the outlet 128), and/or changing the capacity of the reservoir 124 (using the piston 124A). The reservoir capacity may be altered before, after or during the addition and purging of gas from the reservoir 124. In this manner, the buoyancy control system 120 generates a vertical force or thrust (up, if the buoyancy change is positive, or down, if the buoyancy change is negative) on the vehicle 100.

As discussed above, the hull 110 is configured to convert at least a portion of said vertical force into forward thrust (i.e., in the direction +X). In this manner, the vehicle 100 is propelled in a desired direction on a glide path with an angle determined by the LDR of the hull 110. In embodiments wherein the hull 110 has a lift producing shape, the forward movement of the hull 110 can generate a further lift force which can alter the rate of change in depth. The buoyancy control system 120 can repeatedly adjust the vehicle buoyancy (e.g., increasing and decreasing the vehicle buoyancy) so that the vehicle 100 is continuously propelled forward by the buoyancy control system 120 while remaining generally in a desired elevation range. In some embodiments, the buoyancy control system 120 is operated to control a net buoyancy of the vehicle in response to local water density to maintain the vehicle 100 at neutral buoyancy when not being employed to change the elevation of the vehicle 100 in the water 10.

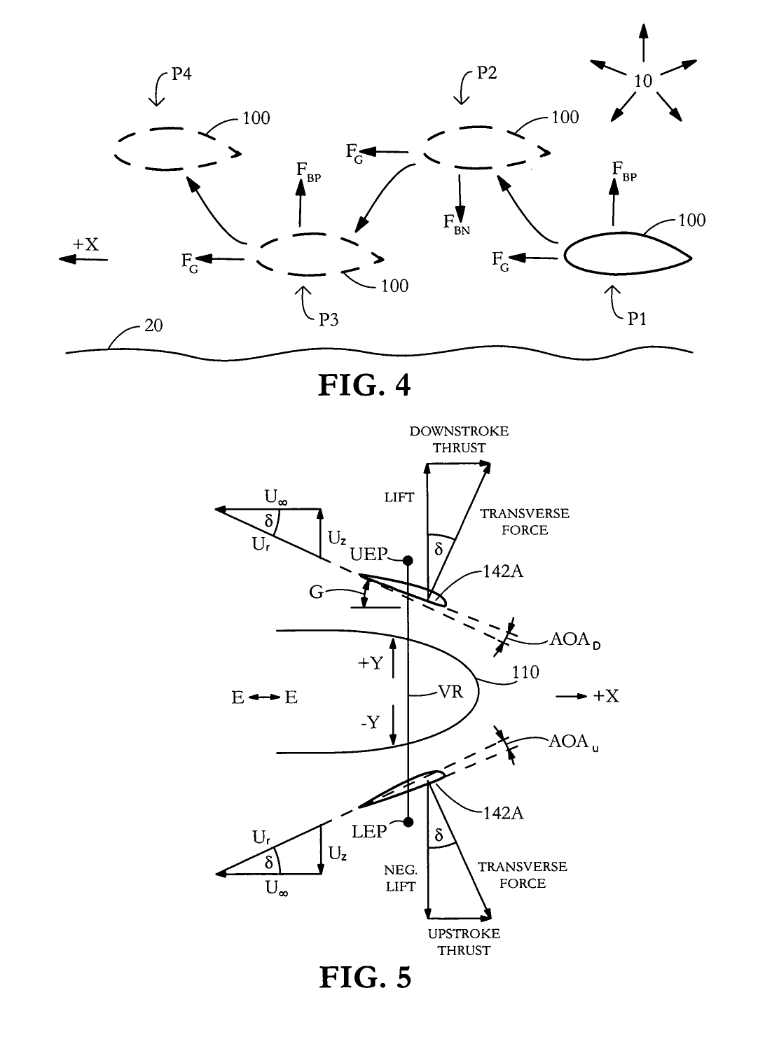

FIG. 4 illustrates operation of the passive thrust system 104A conveying the vehicle 100 through the water 10 and horizontally in the forward direction +X. From a position P1, the buoyancy control system 120 provides the vehicle 100 with a net positive buoyancy to create an upward force vector F_{BP}. The hull 110 converts a portion of the force vector FB_{P} to a horizontally directed gliding force vector F_{G} so that the vehicle 100 glides or transits upwardly and forwardly to a second position P2. The buoyancy control system 120 then provides the vehicle 100 with a net negative buoyancy to create a downward force vector F_{BN}. The hull 110 converts a portion of the force vector F_{BN} to a horizontally directed gliding force vector F_{G} so that the vehicle 100 glides downwardly and forwardly to a third position P3. The buoyancy control system 120 can again increase the vehicle buoyancy to a net positive buoyancy to glide the vehicle 100 upwardly and forwardly to a fourth position P4 and so forth. While the vehicle 100 is illustrated as traveling in a generally sinusoidal path, other travel paths may be provided.

The active thrust system 104B can be used to navigate, which may include translating, rotating or station keeping. In the case of translating, the active thrust system 104B moves the body 102 in a positive or negative direction in at least one of the three dimensions defining physical space. In the case of rotating, the active thrust system 104B may turn, pitch, heave and/or roll the body 102. In the case of station keeping, the active thrust system 104B causes the body 102 to hover and/or loiter, which in some instances may include counteracting a current or the like tending to move the body 102.

More particularly, the active thrust system 104B propels the vehicle 100 in the forward direction +X or other desired direction by operation of the fin system 140. The fin system 140 may also be used to steer the vehicle 100 (e.g., by inducing turn, pitch, heave and/or roll of the body 102) and provide station keeping. According to some embodiments, the fin system 140 pitches and heaves the fins 142A, 142B with respect to the hull 110 in a manner generating lift and/or drag to generate thrust in a desired direction. In some cases, the fins 142A, 142B are moved in a desirable pattern, magnitude, and/or repetition rate to generate a desired thrust. The fin system 140 can control or coordinate the timing and action of the pitch actuators 146 and the heave actuator 148 to provide the desired thrust and steering.

According to some embodiments, the fin system 140 moves the fins 142A, 142B in an oscillating heave-yoke pattern that generates a net forward thrust on the vehicle through both upstroke and downstroke of the fins 142A, 142B. The paths of the fins 142A, 142B may resemble the paths of the wings of a cruising seagull or swan, for example.

Navigating can be conducted by operating the pitch actuators 146A, 146B and the heave actuator 148 in a coordinated manner. According to some embodiments, the heave actuator 148 is operated to provide oscillatory heave movement (i.e., repeated upward and downward movement) of the fins 142A, 142B while the pitch actuators 146A, 146B are operated to controllably vary the pitches of the fins 142A, 142B. In some cases, the pitch actuators 146A, 146B are operated independently to provide different attack angles for each of the first fin 142A and the second fin 142B at a given point in time.

FIG. 5 shows an exemplary path FP of travel of the fin 142A shown as the excursion of the fin tip seen in lateral view. The fin motion path FP is executed by selectively positively raising the fin 142A in an upward direction +Y and lowering the fin 142A in a downward direction −Y using the heave actuator 148, and also selectively positively rotating the fin 142A about the pitch axis B-B (FIG. 3) using the pitch actuator 146A.

In some embodiments, the pitch orientation of the fin 142A, as provided by rotation of the fin shaft 144 by the pitch actuator 146A, is controlled such that the fin 142A has a positive angle of attack during the downstroke and a negative angle of attack during the upstroke. Angle of attack is defined as the angle of the fin 142A with respect to the direction of the flow of water immediately or closely adjacent the surface of the fin 142A. In some embodiments, the pitch orientation of the fin 142A is adjusted at each point of the excursion so that the fin 142A generates net positive lift during the downstroke and net negative lift during the upstroke by rotating the fin shaft 144 to provide a positive and negative angle of attack with respect to the flow around the fin 142 as determined by motion of the fin 142A with respect to the body 102 (i.e., due to heave actuation, as well as movement of the vehicle 100 through the water 10).

A more particular exemplary embodiment will now be described with reference to FIG. 5. In FIG. 5, the uppermost and lowermost stroke positions for a given oscillation cycle are indicated by end points UEP and LEP, respectively. However, it will be appreciated that other oscillations may have different uppermost and lowermost positions along the vertical range VR. The fin 142A is shown in the top position with the pitch orientation it maintains throughout the downstroke. The fin 142A is shown in the lower position with the pitch orientation it maintains throughout the upstroke. According to some embodiments, the fin 142A is transitioned from the downstroke pitch orientation to the upstroke pitch orientation and vice-versa at positions along the vertical range VR proximate but not at (i.e., prior to) the end point positions UEP, LEP. In FIG. 5, U_{∞} indicates the direction of water flow due to body's 102 forward motion, U_{z} indicates the flow of water due to the up and down movement of the fin 142A, Uᵣ indicates the direction of net relative water flow (i.e., the net of water flow due to body's 102 forward motion and the flow of water due to the up and down movement of the fin 142), AOA_{D} indicates the angle of attack of the fin 142A with respect to the net relative water flow on the downstroke, and AOA_{U} indicates the angle of attack of the fin 142A with respect to the net relative water flow on the upstroke.

The path of the other fin 142B may be a mirror image of the path shown in FIG. 5 (e.g., to provide straight travel), or may be somewhat different or time shifted (e.g., to turn the vehicle 100). In some cases, the pitch actuators 146A, 146B provide the fins 142A, 142B with different angles of attack from one another in order to change the direction of travel of the vehicle 100 (e.g., by causing the body 102 to rotate).

The fin system 140 may provide at least certain significant advantages. The heave-yoke travel path can provide a net forward thrust continuously throughout the travel path FP except, in some cases, at the transitions between the upstroke and downstroke positions. The heave-yoke travel path can efficiently generate forward thrust so that the power available to vehicle 100 is conserved. Manufacturing cost savings and power consumption efficiency are also provided by the use of only three actuators (the heave actuator 148 and the two pitch actuators 146).

The hybrid propulsion system 104 may also provide at least certain significant advantages. The passive thrust system 104A can provide particularly efficient forward thrust so that, when relatively slow travel is adequate, the vehicle 100 can transit using less power. In this case, the active thrust system 104B may remain unused or may be used only for purposes of steering. When relatively faster travel is desired or required, the active thrust system 104B may be employed in addition to or in place of the passive thrust system 104A to provide faster transit of the vehicle 100.

The fin system 140 may also be used to dig, uncover, and/or provide force and torque with respect to the substratum 20.

In some cases, the fin system 140, which is used to provide active thrust, can also be used as a force redirector in cooperation with the buoyancy control system 120 to provide passive thrust by orienting the fins 142A, 142B to convert vertical force (e.g., generated by the buoyancy control system 120) into horizontally directed thrust in the same or similar manner as discussed with regard to the hull 110. In some embodiments, the fins 142A, 142B are used in combination with the hull shape to provide passive thrust as described herein. However, in other embodiments, fins (which may be fins that are also used to provide active thrust) may be used to convert vertical force into horizontal force without the benefit of a hull that provides such conversion.

The vehicle 100 can be used to carry a payload to a desired location. The vehicle 100 can carry one or more sensors for operations. An illustrative payload includes one or more sensors or a sensing array. In some cases, the sensor and/or array is deployable. A second illustrative payload includes a neutralization charge. A third illustrative payload is materiel for personnel. A fourth illustrative payload is a releasable device for communicating from proximate the water surface. A fifth illustrative includes a marker that can provide a signal, such as for navigation aiding and/or communicating.

The vehicle 100 can be navigated to establish an operating position, and may be further navigated to establish a second, subsequent operating position. In some cases, the operating position is established by settling on or, at least partly, in sediment.

The vehicle 100 may be used to conduct surveillance and/or survey in the operational area. In some cases, the vehicle 100 detects signals and/or images, water parameters, and/or events. In some cases, the vehicle 100 communicates responsive to detecting. In some cases, the vehicle 100 deposits and/or releases a payload. In some cases, the vehicle 100 operates or monitors a deposited or deployed payload. In some cases, the vehicle 100 recovers an object. In some cases, the vehicle 100 interchanges energy and/or data with a secondary object. One example is providing energy and/or data to a secondary object. In another example, the vehicle 100 retrieves data from a secondary object. In some embodiments, the secondary object includes a sensing system deployed in the substratum 20. In some embodiments, the secondary object includes another vehicle.

The sensor device 172 may be used to determine a location of the vehicle 100 such as by GPS or compass reading. In some cases, the sensor device 172 detects signals and/or water parameters. In some cases, signal detection by the sensor device 172 includes processing signals and/or parameters according to an algorithm. In some cases, the sensor device 172 senses signals (e.g., acoustic, optical, electrical, or magnetic) indicative of a desirably sensed construction. In some cases, the sensor device 172 determines an environmental potential (e.g., redox potential) of sediment. In some cases, the sensor device 172 infers a location of the vehicle (e.g., from signals of opportunity). The results of detecting may be processed to classify a signal and/or its source or to provide a derived parameter such as a sound velocity, a water current profile and or a water salinity profile, for example.

The vehicle 100 may be used to service a secondary object (e.g., sensing array deployed on the sediment) such as by conducting energy and/or data with respect to the secondary object. In some cases, energy is conducted to recharge batteries of the secondary object. In some cases, operational instructions, algorithms or related data are transferred to the secondary object (e.g., a signature representative of a vessel expected to transit in the vicinity of the vehicle). In some cases, the vehicle 100 receives data from a secondary object, such as the results of detecting and/or processing of signals by the secondary object. In some cases, the vehicle 100 receives energy from a secondary object such as another vehicle as disclosed herein.

In some embodiments, at least a portion of a communications device 170 is deployed to communicate. The communications module 170 may send data reflective of location and/or results of processing. In some cases, the vehicle 100 releases an expendable communication devices such as disclosed in co-assigned U.S. patent application Ser. Nos. 11/494,941 and 11/495,134, the disclosures of which are incorporated herein by reference. In some cases, the communications device 170 uses a radio and/or an optical or acoustic transponder. In some cases, the communications device 170 receives signals such as commands, algorithm updates, or operational data.

The recharging system 180 can be used to provide energy to the battery 188 or another device capable of storing or consuming the energy. In order to recharge, the vehicle 100 may establish a position proximate the substratum 20 at a desirable location, such as on redox potential providing sediments. The vehicle 100 can activate the flow control system 186 to provide a desirable flow of water with respect to the recharger 180 and the anode 182. In some cases, the vehicle 100 can extend the barrier 186A into or adjacent the substratum 20, open the valve 186D and actuate the pump 186C to draw pore water (i.e., interstitial water between sand (and other sediment) grains with organic matter dissolved therein) into the bay 184 and expel the water through the outlet 186B. The valve 186D may only be open during pumping so that the cathode 183 is otherwise electrically isolated from the anode 182.

The recharger 180 can recharge by converting environmental potentials (e.g., redox potentials) established in sediment by microbes. In order to convert these environmental potentials, the anode type electrode 182 is exposed to a potential to induce electrical energy in the electrode 182. The induced electrical energy can be stored in an energy storing component such as the battery 188. In some cases, the energy is provided to a second object such as another vehicle or to a sensor or communication device, such as surveillance and/or other operational system.

With reference to FIG. 8, a water submersible vehicle 200 according to further embodiments of the invention is shown therein. The vehicle 200 corresponds to the vehicle 100 except that the active thrust system 204B of the vehicle 200 includes a propeller system 250 in place of or in addition to the fin system 140. The propeller system 250 includes a propeller 252, shaft 254, and motor 256. Rotation of the propeller 252 can provide thrust and can displace sediment as discussed above with regard to the fin system 140. The vehicle 200 may include a fin system 240 with fins 242 to provide steering of the vehicle 200.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. In the claims, means-plus-function clauses are intended to cover the structures described herein as performing the recited function and not only structural equivalents but also equivalent structures. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

1. A submersible vehicle for use in water, the submersible vehicle comprising:
a vehicle body; and
a hybrid vehicle propulsion system to propel the vehicle body through the water, the hybrid vehicle propulsion system including:
a passive thrust system including a force redirector and a buoyancy control system, wherein the buoyancy control system is operable to selectively generate vertical thrust by varying a buoyancy of the submersible vehicle and the force redirector is configured to generate a glide thrust responsive to changes in the elevation of the submersible vehicle in the water;
an active thrust system including a thruster mechanism operable to selectively propel and/or steer the vehicle body through the water; and
a vehicle controller operative:
to use the buoyancy control system in a slow travel operation to selectively generate vertical thrust by varying the buoyancy of the submersible vehicle;
while in the slow travel operation, to idle the active thrust system or steer with the active thrust system; and
to propel and/or steer the vehicle body through the water using the thruster mechanism in a travel operation faster than the slow travel operation to provide a faster transit of the submersible vehicle.

2. The submersible vehicle of claim 1 wherein the force redirector includes a vehicle hull.

3. The submersible vehicle of claim 2 wherein the vehicle hull is a lift generating hull.

4. The submersible vehicle of claim 1 wherein the force redirector includes a fin.

5. The submersible vehicle of claim 4 wherein a pitch angle of the fin with respect to the body is selectively adjustable.

6. The submersible vehicle of claim 4 including a vehicle hull that is also configured to generate a glide thrust responsive to changes in the elevation of the submersible vehicle in the water.

7. The submersible vehicle of claim 4 wherein the thruster mechanism includes the fin and an actuator to controllably move the fin.

8. The submersible vehicle of claim 1 wherein the thruster mechanism includes a fin and an actuator to controllably move the fin.

9. The submersible vehicle of claim 8 wherein the thruster mechanism includes:
a pair of opposed fins;
a pair of pitch actuators each associated with a respective one of the fins to selectively vary a pitch of the associated fin; and
a heave actuator to selectively change an angle between the fins.

10. The submersible vehicle of claim 9 wherein the heave actuator is operative to move each fin in each of an upstroke and a downstroke, and the thruster mechanism is operative to control the pitch of each fin such that the fin generates net positive lift during its downstroke and the fin generates net negative lift during its upstroke.

11. The submersible vehicle of claim 1 wherein the thruster mechanism includes a propeller and an actuator to controllably drive the propeller.

12. The submersible vehicle of claim 1 wherein the buoyancy control system is operative to adjust a net buoyancy of the submersible vehicle in response to a local water density.

13. The submersible vehicle of claim 1 wherein the submersible vehicle is an unmanned underwater vehicle (UUV).

14. The submersible vehicle of claim 13 including a guidance and control system to enable navigation of the UUV.

15. The submersible vehicle of claim 1 including a recharging system associated with the vehicle body and including a convertor operative to convert environmental potential proximate the vehicle to electrical energy.

16. A method of propelling a submersible vehicle through water, the method comprising:
providing a submersible vehicle for use in water, the submersible vehicle including:
a vehicle body; and
a hybrid vehicle propulsion system to propel the vehicle body through the water, the hybrid vehicle propulsion system including:
a passive thrust system including a force redirector and a buoyancy control system; and
an active thrust system including a thruster mechanism;
in a slow travel operation, using the buoyancy control system, selectively generating vertical thrust by varying a buoyancy of the submersible vehicle and thereby changing the elevation of the submersible vehicle in the water, responsive to which the force redirector generates a glide thrust;
in the slow travel operation, one of idling the active thrust system and steering with the active thrust system; and
in a travel operation faster than the slow travel operation, propelling and/or steering the vehicle body through the water using the thruster mechanism.

17. (canceled)

18. The submersible vehicle of claim 15 including a battery and wherein the recharging system is configured to recharge the battery.

19. The submersible vehicle of claim 15 wherein the electrical energy from the recharging system is consumed by the submersible vehicle.

20. The submersible vehicle of claim 19 including a propulsion system operable to drive the submersible vehicle through the water, wherein the electrical energy from the recharging system powers the propulsion system.

21. The submersible vehicle of claim 15 wherein the converter includes a bioreactor.

22. The submersible vehicle of claim 21 wherein the converter includes a redox potential convertor operable to convert redox potentials to electrical energy.

23. (canceled)

24. (canceled)

25. The submersible vehicle of claim 10 wherein the fin propulsion system is operative to coordinate the timing of actuation of the pitch actuators and the heave actuator.

26. (canceled)

27. The submersible vehicle of claim 1 wherein the vehicle controller is further operative to control the active thrust mechanism in a station keeping operation to resist drift caused by an ocean current.

28. The submersible vehicle of claim 27 wherein:
the thruster mechanism includes a fin and an actuator to controllably move the fin; and
the vehicle controller is operative to control the actuator in the station keeping operation to use the fin to resist drift caused by an ocean current.

29. The method of claim 16 further including, in a station keeping operation, using the active thrust mechanism to resist drift caused by an ocean current.

30. The method of claim 29 wherein:
the thruster mechanism includes a fin and an actuator to controllably move the fin; and
the method includes, in the station keeping operation, using the actuator to control the fin to resist drift caused by an ocean current.

31. The method of claim 16 wherein the submersible vehicle is an unmanned underwater vehicle (UUV).
